(19) United States
(12) Patent Application Publication
(10) Pub. No.: US 2008/0198439 A1
(43) Pub. Date: Aug. 21, 2008

(54) MAGNETIC DISPLAY PIXEL AND MAGNETIC DISPLAY PANEL

(75) Inventor: Sung Nae CHO, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/028,253

(22) Filed: Feb. 8, 2008

(30) Foreign Application Priority Data
Feb. 16, 2007 (KR) 10-2007-0016783
May 11, 2007 (KR) 10-2007-0046199
Aug. 10, 2007 (KR) 10-2007-0080599

(51) Int. Cl. G02F 1/09

(52) U.S. Cl. 359/280

(57) ABSTRACT

Provided are a magnetic display pixel using an optical shutter having a magnetic material layer, and a magnetic display panel including the magnetic display pixel. The magnetic display pixel includes a magnetic material layer that transmits light when a magnetic field is applied and does not transmit the light when the magnetic field is not applied, a first electrode arranged on a lower surface of the magnetic material layer, a second electrode arranged on an upper surface of the magnetic material layer, and a spacer arranged at a side surface of the magnetic material layer to electrically connect the first electrode and the second electrode.

### CROSS-REFERENCE TO RELATED PATENT APPLICATIONS

This application claims the benefit of Korean Patent Application No. 10-2007-0016783, filed on Feb. 16, 2007, No. 10-2007-0046199, filed on May 11, 2007, and No. 10-2007-0080599, filed on Aug. 10, 2007, in the Korean Intellectual Property Office, the disclosure of which is incorporated herein in its entirety by reference.

### BACKGROUND OF THE INVENTION

1. Field of the Invention

Apparatuses consistent with the present invention relate to a magnetic display pixel using an optical shutter having a magnetic material layer, and a magnetic display panel including the magnetic display pixel.

2. Description of the Related Art

Recently, liquid crystal display (LCD) panels and plasma display panels (PDPs) are widely used as flat panel displays. Also, an organic light emitting diode (OLED) is under development as a next-generation flat panel display.

An LCD panel, which is not an emissive type, needs an optical shutter for transmitting/blocking light emitted from a backlight unit or an external light. The optical shutter used in the LCD panel includes two polarization plates and a liquid crystal layer arranged between the polarization plates. When the polarization plates are an absorptive type, light use efficiency is much degraded. Accordingly, research regarding using a reflective type polarization plate instead of the absorptive type polarization plate are being carried out. However, in this case, manufacturing costs increase and a large size display panel is difficult to make.

A plasma display panel of an emissive type does not need the optical shutter as in the LCD panel. However, there is a problem in that power consumption increases much and a large amount of heat is generated. Also, the OLED is now at a stage of development and also has a problem of high manufacturing costs and a limited life span.

### SUMMARY OF THE INVENTION

To solve the above and/or other problems, the present invention provides a magnetic display pixel using an optical shutter formed of a magnetic material, not liquid crystal, and a magnetic display panel including the magnetic display pixel.

The present invention provides an electronic apparatus employing the magnetic display panel.

According to an aspect of the present invention, a magnetic display pixel comprises a magnetic material layer that transmits light when a magnetic field is applied and does not transmit the light when the magnetic field is not applied, a first electrode arranged on a lower surface of the magnetic material layer, a second electrode arranged on an upper surface of the magnetic material layer, and a spacer arranged at a side surface of the magnetic material layer to electrically connect the first electrode and the second electrode.

The magnetic display pixel further comprises a first transparent substrate arranged on the first electrode and a second transparent substrate arranged on the second electrode.

The magnetic material layer transmits light of a first polarization direction and reflects light of a second polarization direction perpendicular to the first polarization direction when the magnetic field is applied and reflects all light when the magnetic field is not applied.

The magnetic material layer has a structure in which a plurality of magnetic particles are distributed in a transparent insulation medium such that the magnetic particles are not agglomerated.

The thickness of the magnetic material layer is greater than the magnetic decay length of the magnetic material layer.

The magnetic material layer includes the magnetic particles in a core-shell structure.

Each core-shell structured magnetic particle includes a magnetic core formed of a magnetic core and an insulation shell surrounding the magnetic core.

The insulation shell is formed of a transparent insulation material surrounding the magnetic core.

The insulation shell is formed of a transparent insulation surfactant in a polymer state and surrounding the magnetic core.

The magnetic core forms a single magnetic domain.

The magnetic body forming the magnetic core is formed of a material selected from the group consisting of titanium, aluminum, barium, platinum, sodium, strontium, magnesium, dysprosium, manganese, gadolinium, silver, copper, chrome, nickel, iron, cobalt, and iron oxide, or an alloy thereof

The magnetic material layer has a structure in which a plurality of magnetic particles in a cylindrical shape are distributed in a transparent insulation medium such that the magnetic particles area not agglomerated.

The magnetic material layer is formed of a magnetic polymer film.

The magnetic display pixel further comprises a color filter arranged between the second electrode and the second transparent substrate or between the first electrode and the first transparent substrate.

The magnetic display pixel further comprises an antireflection coating which is formed on at least one of the optical surfaces from the magnetic material layer to an outer surface of the second transparent substrate.

The magnetic display pixel further comprises an absorptive type polarizer arranged on at least one of the optical surfaces from the magnetic material layer to an outer surface of the second transparent substrate.

The magnetic display pixel further comprises a mirror or a semi-transmissive mirror arranged on at least one of the optical surfaces from the magnetic material layer to an outer surface of the first transparent substrate.

A light transmissive layer is additionally provided between the first electrode and the magnetic material layer or between the second electrode and the magnetic material layer.

The first electrode, the second electrode, and the conductive spacer are formed of any of materials selected from the group consisting of aluminum, copper, silver, platinum, gold, barium, chromium, sodium, strontium, magnesium, and iodine-doped polyacetylene.

A plurality of first holes are formed in an area of the first electrode facing the magnetic material layer to allow light to pass through the first electrode and a plurality of wires extending in a direction in which a current flows are formed in the first holes.

A light transmissive material is formed in the first holes between the wires.

A second hole is formed in an area of the second electrode facing the magnetic material layer to allow light to pass through the second electrode.

A light transmissive material is formed in the second hole of the second electrode.

The second electrode is a wire in a mesh or lattice structure and electrically connected to the conductive spacer.

The first electrode and the second electrode are formed of a transparent conductive material.

The magnetic display pixel further comprises a control circuit arranged at the side of the magnetic material layer and between the first and second transparent substrates and switching the flow of a current between the first electrode and the second electrode.

The magnetic display pixel further comprises a black matrix arranged in an area of a surface of the second electrode facing the control circuit and the conductive spacer.

According to another aspect of the present invention, a magnetic display panel comprising a plurality of the above-described magnetic display pixels.

The magnetic display pixels share the single common first transparent substrate, the second transparent substrate, and the second electrode in a common manner and each of the magnetic display pixels includes the magnetic material layer and the first electrode to apply a magnetic field to the magnetic material layer are arranged by one at each magnetic display pixel.

The magnetic display panel is a flexible display panel in which the first transparent substrate, the second transparent substrate, the first electrode, and the second electrode are formed of a flexible material.

The first and second transparent substrates are formed of a light transmissive resin material and the first and second electrodes are formed of a conductive polymer material.

The magnetic display panel further comprises an organic TFT that is arranged at the side of the magnetic material layer and between the first and second transparent substrates to switch the flow of a current between the first and second electrodes.

The magnetic display panel further comprises a display unit in which a plurality of the magnetic display pixels are arranged and a separate control portion to independently switch the flow of a current between the first and second electrodes with respect to each of the magnetic display pixels.

According to another aspect of the present invention, a double-sided display panel comprises a backlight unit and first and second magnetic display panels symmetrically arranged on both sides of the backlight unit and including a plurality of the above-described magnetic display pixels.

According to another aspect of the present invention, an electronic device employing a magnetic display panel having a plurality of the above-described magnetic display pixels.

### BRIEF DESCRIPTION OF THE DRAWINGS

The above and other features of the present invention will become more apparent by describing in detail exemplary embodiments thereof with reference to the attached drawings in which:

FIG. 1 is a cross-sectional view schematically illustrating the structure of a sub-pixel of a magnetic display panel, according to an exemplary embodiment of the present invention;

FIG. 2 is a perspective view schematically illustrating the structures of a sub-pixel electrode, a conductive spacer, and a common electrode of the sub-pixel of FIG. 1;

FIG. 3A schematically illustrates the distribution of a magnetic field formed around wires of the sub-pixel electrode;

FIG. 3B is a cross-sectional view taken along line A-A′ of FIG. 2, illustrating the structures of the sub-pixel electrode, a magnetic material layer, and the common electrode;

FIG. 4 is a perspective view schematically illustrating the structures of a sub-pixel array and the common electrode of a magnetic display panel, according to an exemplary embodiment of the present invention;

FIG. 5 is a perspective view schematically illustrating the structures of a sub-pixel array and the common electrode of a magnetic display panel, according to another exemplary embodiment of the present invention;

FIG. 6 is a perspective view schematically illustrating the structures of a sub-pixel array and the common electrode of a magnetic display panel, according to another exemplary embodiment of the present invention;

FIG. 7 is a perspective view schematically illustrating the structures of a sub-pixel array and the common electrode of a magnetic display panel, according to another exemplary embodiment of the present invention;

FIG. 8 illustrates the structure of the magnetic material layer of the sub-pixel of FIG. 1;

FIG. 9 is a cross-sectional view of the magnetic material layer of FIG. 8;

FIG. 10 illustrates an example of the structure of a magnetic particle used for the magnetic material layer of FIG. 8;

FIG. 11 illustrates another example of the structure of a magnetic particle used for the magnetic material layer of FIG. 8;

FIGS. 12A and 12B respectively illustrate horizontal cross-sectional and vertical cross-sectional views of other structures of the magnetic material layer;

FIG. 13 schematically illustrates the orientation of magnetic moments in the magnetic material layer when a magnetic field is not applied;

FIG. 14 schematically illustrates the orientation of magnetic moments in the magnetic material layer when a magnetic field is applied;

FIGS. 15 and 16 are graphs showing the transmission of a magnetic field in the magnetic material layer;

FIGS. 17 and 18 are graphs showing the transmittance of a perpendicular light and a parallel light in the magnetic material layer;

FIG. 19 is a cross-sectional view schematically illustrating an operation when the sub-pixel of a magnetic display panel according to the present invention is in an OFF state;

FIG. 20 is a cross-sectional view schematically illustrating an operation when the sub-pixel of a magnetic display panel according to the present invention is in an ON state;

FIG. 21 is a cross-sectional view schematically illustrating the structure of a sub-pixel of a magnetic display panel, according to another exemplary embodiment of the present invention;

FIG. 22 is a cross-sectional view schematically illustrating the structure of a double-sided display panel using the sub-pixel of FIG. 1, according to an exemplary embodiment of the present invention;

FIG. 23 is a cross-sectional view schematically illustrating the operation of the sub-pixels of the double-sided display panel of FIG. 22;

FIG. 24 is a cross-sectional view schematically illustrating the structure of a double-sided display panel using the sub-pixels of the magnetic display panel of FIG. 21, according to an exemplary embodiment of the present invention;

FIG. 25 is a cross-sectional view schematically illustrating the structure of a sub-pixel of a magnetic display panel, according to another exemplary embodiment of the present invention; and

FIG. 26 is a conceptual view illustrating the connection structure between a control portion and a flexible display unit.

### DETAILED DESCRIPTION OF THE INVENTION

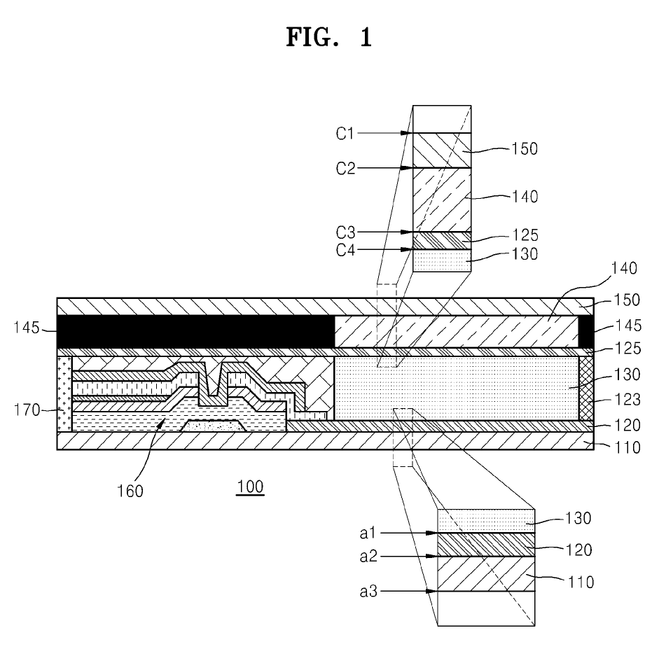

FIG. 1 is a cross-sectional view schematically illustrating the structure of a sub-pixel 100 of a magnetic display panel, according to an exemplary embodiment of the present invention. Referring to FIG. 1, the sub-pixel 100 of a magnetic display panel according to the present exemplary embodiment of the present invention includes first and second transparent substrates 110 and 150 arranged to face each other, a magnetic material layer 130 filled between the first and second transparent substrates 110 and 150, a sub-pixel electrode 120 formed on part of an inner surface of the first transparent substrate 110, a color filter 140 arranged on part of an inner surface of the second transparent substrate 150, a common electrode 125 arranged on a surface of the color filter 140, and a conductive spacer 123 arranged at a side surface of the magnetic material layer 130 to seal the magnetic material layer 130 and electrically connect the sub-pixel electrode 120 and the common electrode 125.

The first and second transparent substrates 110 and 150 and the common electrode 125 are commonly used by all sub-pixels of the magnetic display panel of the present exemplary embodiment. In FIG. 1, the common electrode 125 is arranged on the surface of the color filter 140, and the sub-pixel electrode 120 is arranged on the inner surface of the first transparent substrate 110. However, the positions of the sub-pixel electrode 120 and the common electrode 125 are not limited to as shown in the present exemplary embodiment, and thus, can be switched with each other. Also, when a black and white display is to be provided instead of a color display, the color filter 140 can be omitted.

A control circuit 160, for switching the flow of a current between the sub-pixel electrode 120 and the common electrode 125, is formed on the inner surface of the first transparent substrate 110 and adjacent to the sub-pixel electrode 120. For example, a thin film transistor (TFT) that is commonly used in an LCD panel can be used as the control circuit 160. When the TFT is used as the control circuit 160, for example, and a voltage is applied to a gate electrode of the TFT, the TFT is turned on so that a current flows between the sub-pixel electrode 120 and the common electrode 125.

Also, a barrier 170 is formed vertically between the common electrode 125 and the first transparent substrate 110 along the edge of the sub-pixel 100. With the conductive spacer 123, the barrier 170 completely seals between the common electrode 125 and the first transparent substrate 110.

A black matrix 145 is formed between the common electrode 125 and the second transparent substrate 150 in an area corresponding to the control circuit 160, the barrier 170, and the conductive spacer 123. The black matrix 145 covers the control circuit 160, the barrier 170, and the conductive spacer 123 so that the control circuit 160, the barrier 170, and the conductive spacer 123 are not able to be seen from the outside. Although, in FIG. 1, the black matrix 145 and the color filter 140 are arranged between the common electrode 125 and the second transparent substrate 150, the present invention is not limited thereto, and thus, the black matrix 145 and the color filter 140 can be arranged on an outer surface of the second transparent substrate 150.

Although it is not illustrated in detail in FIG. 1, an anti-reflection coating can be formed on at least one of the optical surfaces from the magnetic material layer 130 to the second transparent substrate 150 to prevent dazzling to the eyes due to reflection and diffusion of an external light. For example, referring to an upper enlarged portion of FIG. 1, the anti-reflection coating can be formed on at least one of a surface c4 between the magnetic material layer 130 and the common electrode 125, a surface c3 between the common electrode 125 and the color filter 140, a surface c2 between the color filter 140 and the second transparent substrate 150, and an upper surface c1 of the second transparent substrate 150. Also, to appropriately reuse an external light passing through the magnetic material layer 130, a mirror or semi-transmissive mirror can be formed on at least one of the surfaces from the magnetic material layer 130 to the first transparent substrate 110. For example, referring to a lower enlarged portion of FIG. 1, a mirror or semi-transmissive mirror can be formed on at least one of a surface al between the magnetic material layer 130 and the sub-pixel electrode 120, a surface a2 between the sub-pixel electrode 120 and the first transparent substrate 110, and a lower surface a3 of the first transparent substrate 110. When the mirror is formed on the entire portion of any of the surfaces a1, a2, and a3, the magnetic display panel can use the external light only for display. When the mirror or semi-transmissive mirror is formed only in a portion of the surfaces a1, a2, and a3, all of the external light and a light from a backlight can be used for display.

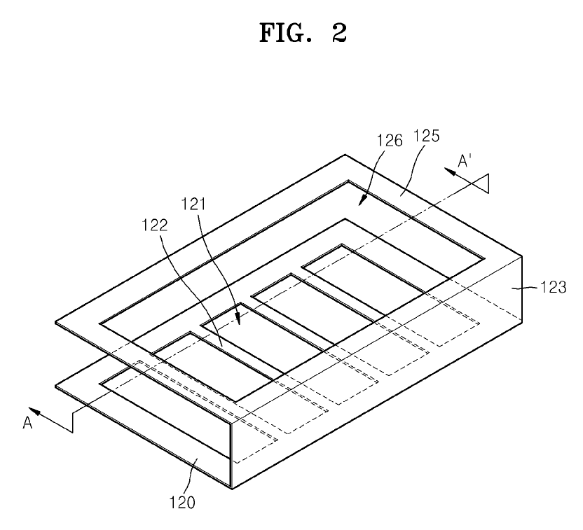

FIG. 2 is a perspective view schematically illustrating the structures of the sub-pixel electrode 120, the conductive spacer 123, and the common electrode 125 of FIG. 1. Referring to FIG. 2, the sub-pixel electrode 120 faces the lower surface of the magnetic material layer 130 of FIG. 1, the common electrode 125 faces the upper surface of the magnetic material layer 130, and the conductive spacer 123 is arranged at the side surface of the magnetic material layer 130 to electrically connect the sub-pixel electrode 120 and the common electrode 125.

The sub-pixel electrode 120, the conductive spacer 123, and the common electrode 125 are formed of, for example, opaque metal having a low resistance such as aluminum (Al), copper (Cu), silver (Ag), platinum (Pt), gold (Au), barium (Ba), chrome (Cr), sodium (Na), strontium (Sr), or magnesium (Mg). In addition to the opaque metal, a conductive polymer such as iodine-doped polyacetylene can be used as a material for the sub-pixel electrode 120, the conductive spacer 123, and the common electrode 125.

When an opaque material is used for the sub-pixel electrode 120, the conductive spacer 123, and the common electrode 125, holes 121 and a hole 126 are respectively formed in the sub-pixel electrode 120 and the common electrode 125 corresponding to the magnetic material layer 130 as shown in FIG. 2 so that light can pass through the sub-pixel electrode 120 and the common electrode 125. The holes 121 are relatively small holes formed parallel to one another in the sub-pixel electrode 120 so that a magnetic field can be easily applied to the magnetic material layer 130. A plurality of wires 122, extending in a direction in which a current flows, remain between the holes 121 from the formation of the holes 121. In contrast, the hole 126 is a relatively large single hole having a size corresponding to that of the magnetic material layer 130.

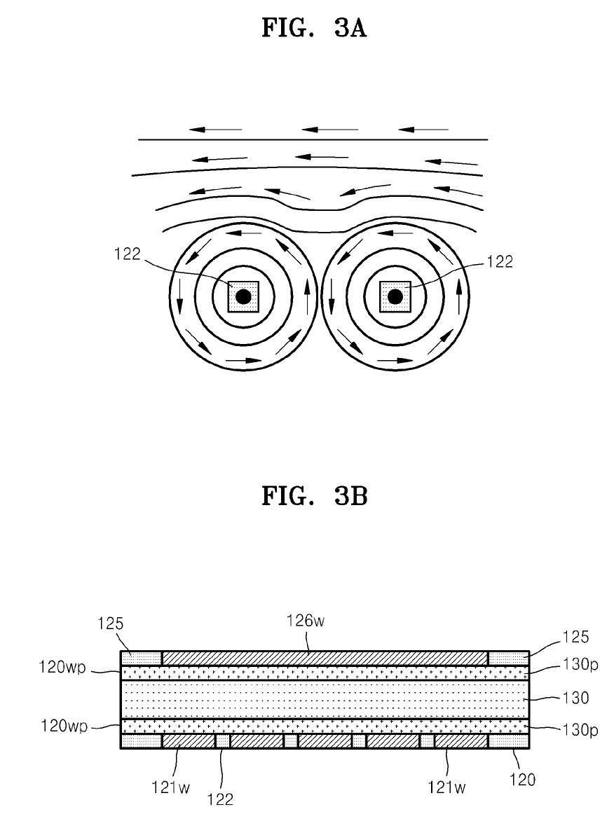

FIG. 3A schematically illustrates the distribution of a magnetic field formed around the wires 122 when a current flows in the wires 122. As shown in FIG. 3A, magnetic field is offset and does not exist in a space between the wires 122 and the magnetic field becomes parallel at locations further from the wires 122. Thus, in an exemplary embodiment, the magnetic material layer 130 may not intrude in the space between the wires 122. Also, in an exemplary embodiment, the magnetic material layer 130 may be separated a predetermined distance apart from the wires 122.

FIG. 3B is a cross-sectional view taken along line A-A′ of FIG. 2, illustrating the structures of the sub-pixel electrode 120, the magnetic material layer 130, and the common electrode 125. Referring to FIG. 3B, light transmissive materials 121w and 126w respectively fill the holes 121 formed between the wires 122 of the sub-pixel electrode 120 and the hole 126 of the common electrode 125. A light transmissive material 130p having a predetermined thickness is provided between the sub-pixel electrode 120 and the magnetic material layer 130 and between the common electrode 125 and the magnetic material layer 130. By doing so, a magnetic field can be uniformly applied to the magnetic material layer 130 and the intrusion of the magnetic material layer 130 into the holes 121 between the wires 122 having a weak or almost no magnetic field can be prevented.

However, a conductive material that is transparent to visible rays, for example, ITO, can be used as a material for the sub-pixel electrode 120 and the common electrode 125. In this case, there is no need to separately form a hole in the sub-pixel electrode 120 and the common electrode 125. A technology to coat a metal very thinly to under several nanometers has recently been developed. When a conductive metal is formed to have a thickness less than a skin depth of the metal, the transmission of light is made possible. Thus, the sub-pixel electrode 120 and the common electrode 125 can be formed by coating the conductive metal to have a thickness that is less than the skin depth of the metal.

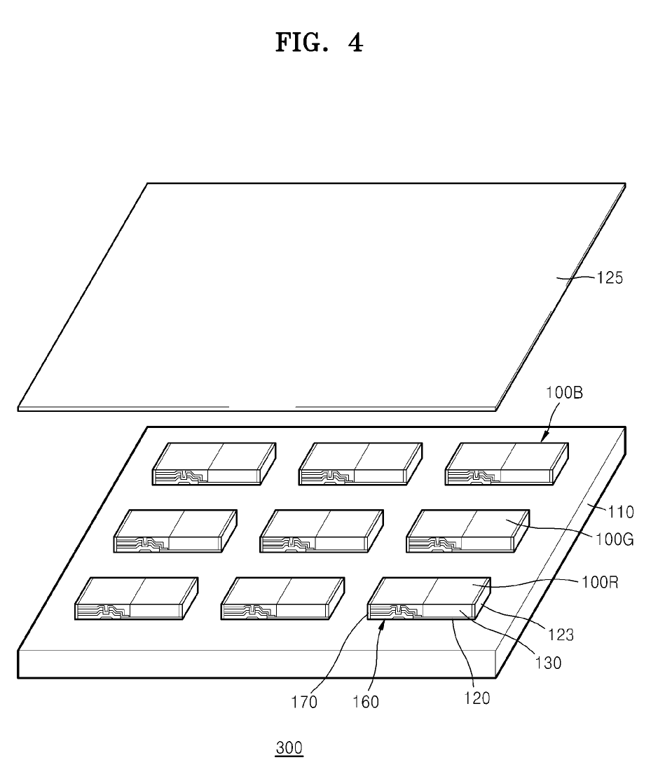

FIGS. 4-6 schematically illustrate arrays of the sub-pixels 100 and various structures of the common electrodes 125 that are common to the sub-pixels 100 in a magnetic display panel 300, according to exemplary embodiments of the present invention. First, referring to FIG. 4, the magnetic display panel 300 includes the sub-pixels 100 arranged in an array form on the first transparent substrate 110 that is single and common to the sub-pixels 100. The sub-pixels 100 each having a different color filter 140 can form a single pixel. For example, as shown in FIG. 4, a sub-pixel 100R having a red color filter, a sub-pixel 100G having a green color filter, and a sub-pixel 100B having a blue color filter make a single pixel.

The sub-pixels 100 of the magnetic display panel 300 according to the present exemplary embodiments include the common electrode 125 that is single and common to the sub-pixels 100. In FIG. 4, the common electrode 125 is a transparent electrode formed of a transparent conductive material such as ITO. In this case, the hole 126, for the passage of light, is not needed in the common electrode 125. In the structure, only when the control circuit 160, arranged at each sub-pixel 100, is turned on, a current flows from the common electrode 125 to the sub-pixel electrode 120 of a corresponding sub-pixel 100 through the conductive spacer 123. The current flows along a very large area in the common electrode 125; however the current flows along a very narrow area in the sub-pixel electrode 120. Thus, a current density of the sub-pixel electrode 120 is much higher than that of the common electrode 125. Thus, the magnetic material layer 130 is affected only by the sub-pixel electrode 120 and minimally affected by the common electrode 125.

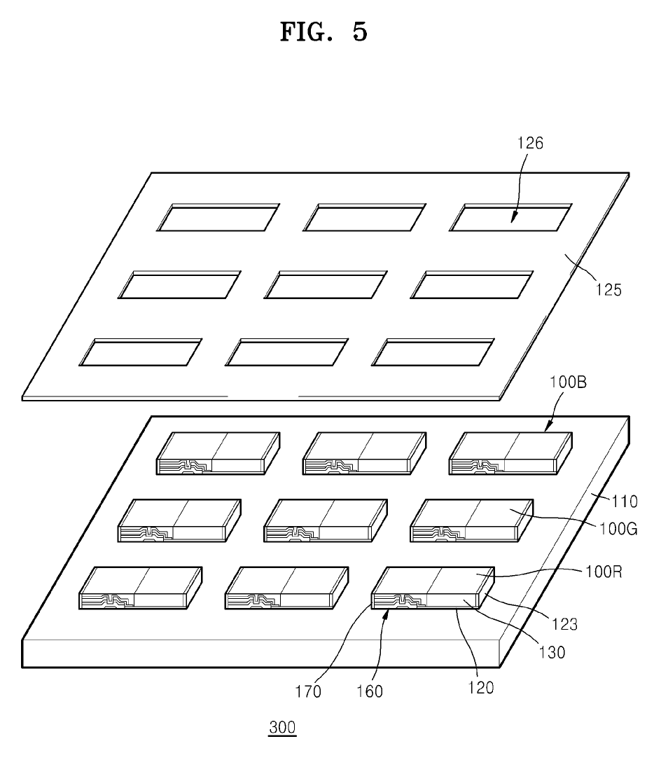

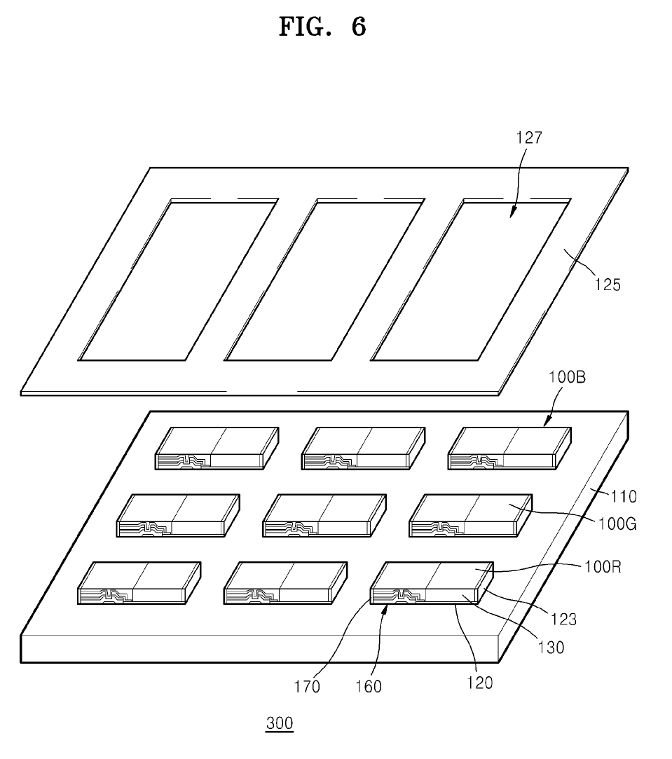

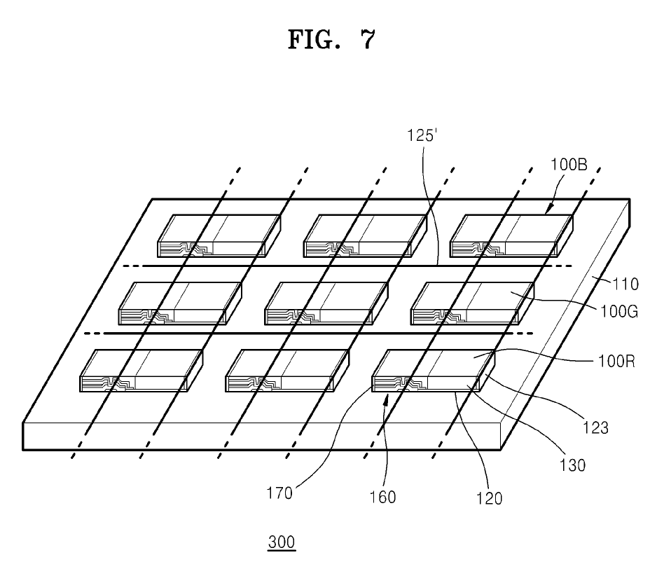

FIGS. 5 and 6 illustrate cases in which the common electrode 125 is formed of an opaque metal or conductive polymer. In FIG. 5, the hole 126, for the light transmission, is formed at every position corresponding to each sub-pixel 100, as also shown in FIG. 2 for the sub-pixel 100. In FIG. 6, a hole 127, for the light transmission and which is relatively larger than the hole 126, is formed in the common electrode 125 at every position corresponding to a single pixel formed of three sub-pixels 100. According to the present invention, the structure of the common electrode 125 is not limited to the shapes of FIGS. 4-6. In FIGS. 4-6, the common electrode 125 is illustrated as a plate type, however, the common electrode 125 can be formed of, for example, a mesh or lattice type wire. FIG. 7 shows a common electrode 125′ having a mesh or a lattice structure. As long as the common electrode 125 is electrically connected to the conductive spacer 123 of each sub-pixel, the common electrode 125 can have different shapes. Also, although in FIGS. 4-6 the common electrode 125 and the sub-pixel electrode 120 are placed at different substrates, the common electrode 125 and the sub-pixel electrode 120 can be formed on the same substrate.

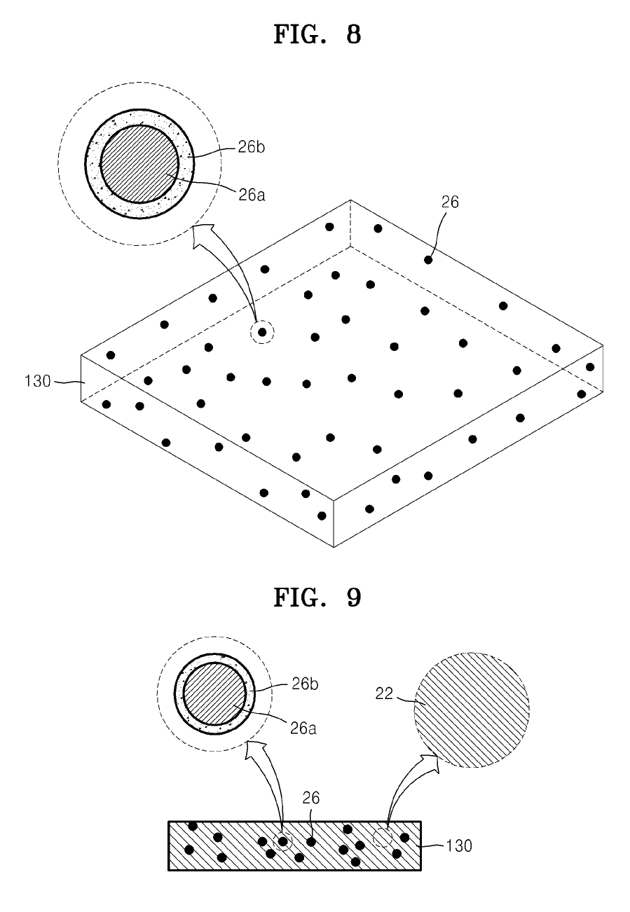

FIG. 8 illustrates the structure of the magnetic material layer 130 of the sub-pixel 100 of FIG. 1. FIG. 9 is a cross-sectional view of the magnetic material layer 130 of FIG. 8. Referring to FIGS. 8 and 9, the magnetic material layer 130 has a structure in which a plurality of magnetic particles 26, each having a magnetic core, are distributed in a transparent insulation material 22 such that the magnetic particles 26 are not agglomerated or electrically contacting one another. In FIGS. 8 and 9, for convenience of explanation, the magnetic particles 26 are depicted as being sparsely distributed in the magnetic material layer 130 for illustrative purposes. However, in an exemplary embodiment, the magnetic particles 26 fill the magnetic material layer 130 very densely. To prevent the magnetic particles 26, having the magnetic core, from being agglomerated or electrically contacting one another, each of the magnetic particles 26 is formed of a magnetic core 26a having a conductivity and an insulation shell 26b that is transparent and non-magnetic and surrounds the magnetic core 26a. A space between the magnetic particles 26 can be filled with a transparent, non-magnetic, and insulating dielectric material like the insulation shell 26b.

The magnetic material layer 130 can be formed by mixing the magnetic cores 26a in a transparent insulation material 22 in a paste state and thinly coating the mixture on the sub-pixel electrode 120, and then, curing the coated mixture. Also, the magnetic material layer 130 can be formed by dipping the magnetic particles 26 having a core-shell structure in a solution and performing spin coating or deep coating of the solution thinly on the sub-pixel electrode 120, and then, curing the coated solution. Furthermore, the magnetic material layer 130 can be formed by directly attaching a conductive magnetic polymer film to the sub-pixel electrode 120, wherein the conductive magnetic polymer film has a magnetic characteristic that is recently being developed and sold. Also, the magnetic material layer 130 can be formed by dipping a mixture of a magnetic core and an insulating transparent non-magnetic core in a solution and performing spin coating or deep coating of the solution thinly on the sub-pixel electrode 120, and then, curing the coated solution. Other methods can be employed as long as the magnetic particles 26 are not combined together or electrically contact one another.

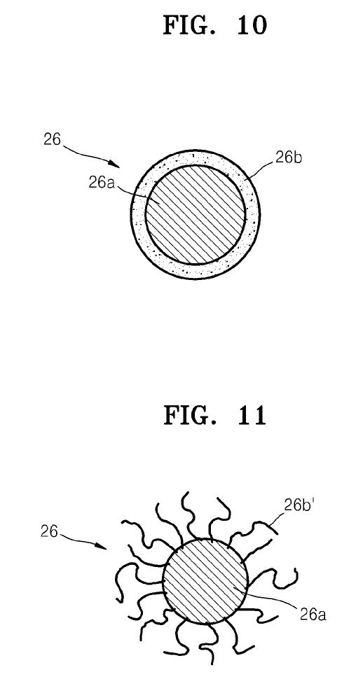

FIGS. 10 and 11 illustrate the core-shell structures of the magnetic particle 26 forming the magnetic material layer 130. As shown in FIGS. 10 and 11, the magnetic particle 26 can be formed of the magnetic core 26a having a conductivity and formed of a magnetic material, and insulation shells 26b and 26b′ surrounding the magnetic core 26a. Since the magnetic core 26a is required to exhibit characteristics as a magnetic body, any material except for ferromagnetic bodies can be used for the magnetic core 26a of the magnetic particle 26. For example, a paramagnetic metal or alloy such as titanium, aluminum, barium, platinum, sodium, strontium, magnesium, dysprosium, manganese, and gadolinium, or a diamagnetic metal or alloy such as silver or copper can be used for the magnetic core 26a. Also, an anti-ferromagnetic metal such as chromium, which is able to change to a paramagnetic body at a temperature above the Neel temperature, can be used for the magnetic core 26a. Furthermore, a ferromagnetic metal, such as cobalt, iron, nickel, or an alloy including any of the ferromagnetic metals, or an alloy thereof, can be used for the magnetic core 26a by providing a super-paramagnetic characteristic. To make the ferromagnetic body have the super-paramagnetic characteristic, the volume of the magnetic core 26a must be sufficiently less than that of a single magnetic domain. In addition to metals, since having the characteristics as a magnetic body are required to be exhibited in the magnetic core 26a, a material such as a dielectric, a semiconductor, or a polymer can be used for the magnetic core 26a. Also, a ferromagnetic substance exhibiting a low conductivity, but with a very high magnetic susceptibility, for example, iron oxides such as MnZn(Fe₂O₄)₂, MnFe₂O₄, Fe₃O₄, and Fe₂O₃, and S₈CaRe₃Cu₄O₂₄, can be used for the magnetic core 26a.

The diameter of the magnetic core 26a must be sufficiently small such that a single unit of the magnetic core 26a can form a single magnetic domain. Thus, the diameter of the magnetic core 26a of the magnetic particles 26 may be several nanometers to tens of nanometers according to the material in use. For example, the diameter of the magnetic core 26a can be about 1 nm through 200 nm, however, the diameter varies according to the material in use.

The insulation shells 26b and 26b′ prevent the magnetic cores 26a that neighbor each other from being agglomerated or directly contacting one another so as to avoid electric contact between the magnetic cores 26a. For this purpose, as shown in FIG. 10, the insulation shell 26b, formed of a non-magnetic, transparent, and insulating dielectric material, for example, SiO₂ or ZrO₂, surrounds the magnetic core 26a. Also, as shown in FIG. 11, the insulation shell 26b′, formed of a surfactant in a polymer state, encompasses the magnetic core 26a. The polymer type surfactant must be transparent and exhibit insulation and non-magnetic characteristics. The insulation shells 26b and 26b′ must be sufficiently thick to avoid the conduction between the neighboring magnetic cores 26.

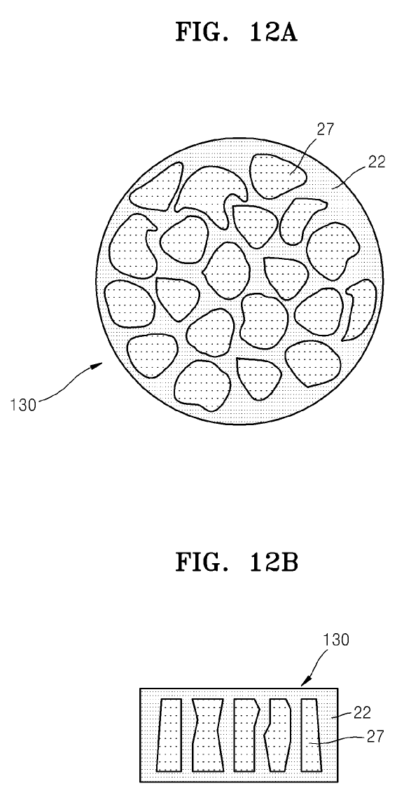

FIGS. 12A and 12B respectively illustrate horizontal cross-sectional and vertical cross-sectional views of other structures of the magnetic material layer 130. In the magnetic material layer 130 of FIGS. 12A and 12B, a plurality of magnetic particles 27 in a cylinder shape, instead of the core-shell, are distributed in the transparent insulation material 22 such as SiO₂. In this case, each of the magnetic particles 27 has a size enough to form a single magnetic domain and can be formed using the above-described magnetic materials. This structure can be made, for example, by forming a dielectric template having a plurality of fine pores using an anodic oxidation method and filling the dielectric template with a magnetic material in a sputtering method.

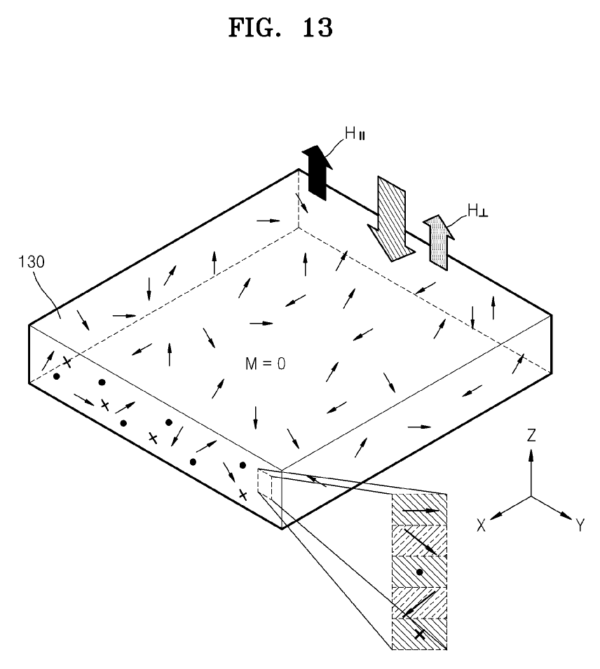

FIG. 13 schematically illustrates the orientation of magnetic moments in the magnetic material layer 130 when a magnetic field is not applied. When a magnetic field is not applied, the overall magnetic moments in the magnetic material layer 130 are randomly oriented in various directions as indicated by the arrows in FIG. 13. In FIG. 13, “” indicates the magnetic moment in a +x direction on an x-y plane and “x” indicates the magnetic moment in a −x direction on the x-y plane. Also, as shown in an enlarged portion in FIG. 13, the magnetic moments in the magnetic material layer 130 are randomly oriented not only in a direction along the x-y plane, however, also in a vertical direction, that is, a −z direction. Thus, when the magnetic field is not applied, the total magnetism in the magnetic material layer 130 is 0 (M=0).

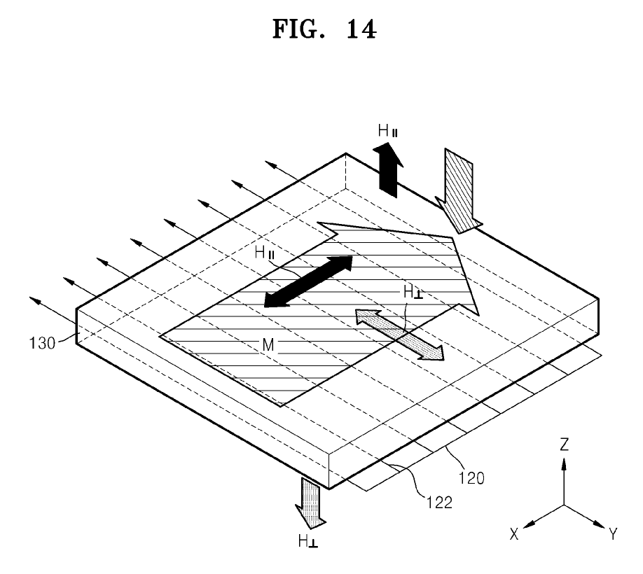

FIG. 14 schematically illustrates the orientation of magnetic moments in the magnetic material layer 130 when a magnetic field is applied. A means for applying a magnetic field to the vicinity of the magnetic material layer 130 is through the sub-pixel electrode 120 arranged on the lower surface of the magnetic material layer 130. In particular, when the sub-pixel electrode 120 is formed of an opaque metal, the magnetic field is applied to the vicinity of the magnetic material layer 130 through the wires 122 of the sub-pixel electrode 120 extending in a direction in which the current flows. For example, as shown in FIG. 14, when the current is applied to the sub-pixel electrode 120 so that the current flows in a −y direction along the wires 122, the magnetic material layer 130 is magnetized in the −x direction. That is, the magnetic moments in the magnetic material layer 130 are all oriented in the −x direction.

According to the principle of the transmission and blocking of the light in the magnetic material layer 130 having the above-described structure, a magnetic field with an electromagnetic wave incident on the magnetic material layer 130 can be separated into a component H_{|} that is perpendicular to a magnetization direction of the magnetic material layer 130 and a component H_{∥} that is parallel to the magnetization direction of the magnetic material layer 130. When the component H_{∥} is incident on the magnetic material layer 130, the component H_{∥} interacts with the magnetic moments oriented in the magnetization direction so that an induced magnetic moment is generated. The induced magnetic moment varies according to time as the amplitude of a magnetic field of the component H_{∥} varies according to time. As a result, an electromagnetic wave is generated by the time-varying induced magnetic moment according to a general principle of the radiation of an electromagnetic wave. The electromagnetic wave can be propagated in all directions. However, the electromagnetic wave traveling in the magnetic material layer 130, that is, an electromagnetic wave traveling in a −z direction, is attenuated by the magnetic material layer 130. When the thickness t of the magnetic material layer 130 is larger than a magnetic decay length, which is a concept similar to the skin depth length of an electric field, of the electromagnetic wave generated by the induced magnetic moment, most of the electromagnetic wave traveling in the magnetic material layer 130 is attenuated and only an electromagnetic wave traveling in a +z direction is left. Thus, the component H_{∥} can be regarded as being reflected from the magnetic material layer 130.

In contrast, when the component H is incident on the magnetic material layer 130, the component H_{⊥} does not interact with the magnetic moment so that no induced magnetic moment is generated. As a result, the component H_{⊥} passes through the magnetic material layer 130 without attenuation.

Consequently, of the magnetic field of the electromagnetic wave incident on the magnetic material layer 130, the component H_{∥} is reflected from the magnetic material layer 130 and the component H_ passes through the magnetic material layer 130. Thus, light energy (S_{∥}=E_{∥}×H_{∥}) related to the magnetic field of the component H_{∥} is reflected from the magnetic material layer 130 and light energy (S_=E_{⊥}×H_{⊥}) related to the magnetic field of the component H_{⊥} passes through the magnetic material layer 130.

In FIG. 13, when the magnetic field is not applied to the magnetic material layer 130, the magnetic moments in the magnetic material layer 130 are randomly oriented not only along the x-y plane but also in a depth direction, that is, the −z direction. Accordingly, all of the light incident on the magnetic material layer 130 to which the magnetic field is applied is reflected. In contrast, as shown in FIG. 14, when the magnetic field is applied to the magnetic material layer 130, the magnetic moments in the magnetic material layer 130 are aligned in a direction. Thus, of the light incident on the magnetic material layer 130, a light having a polarization component related to the component H_{∥} is reflected from the magnetic material layer 130 and a light having a polarization component related to the component H_{|} passes through the magnetic material layer 130. In conclusion, the magnetic material layer 130 blocks light when the magnetic field is not applied and transmits light when the magnetic field is applied, thus functioning as an optical shutter.

To perform an optical shutter function, the magnetic material layer 130 needs to have a thickness to sufficiently attenuate the electromagnetic wave traveling in the magnetic material layer 130. That is, as described above, the thickness t of the magnetic material layer 130 must be greater than the magnetic decay length of the magnetic material layer 130. In particular, when the magnetic material layer 130 is formed of the magnetic cores distributed in a transparent medium, a sufficient number n of the magnetic cores must exist along a path in which the light travels in the magnetic material layer 130. For example, when the magnetic material layer 130 is formed by stacking a plurality of the same layers on the x-y plane in the z direction in which the magnetic cores are uniformly distributed in a single layer, the number n of the magnetic cores needed along the path of the light traveling in the -z direction can be given by the following equation.

n≧s/d [EQN. 1]

Here, “s” is the magnetic decay length of the magnetic core at the wavelength of an incident light and “d” is the diameter of the magnetic core. For example, when the diameter of the magnetic core is 7 nm and the magnetic decay length of the magnetic core at the wavelength of the incident light is 35 nm, five magnetic cores are needed along the path of the light. Thus, when the magnetic material layer 130 is formed of the magnetic cores distributed in a transparent medium, the thickness t of the magnetic material layer 130 can be determined so that “n” or a greater number of the magnetic cores exists in the thickwise direction of the magnetic material layer 130 in consideration of the density of the magnetic core.

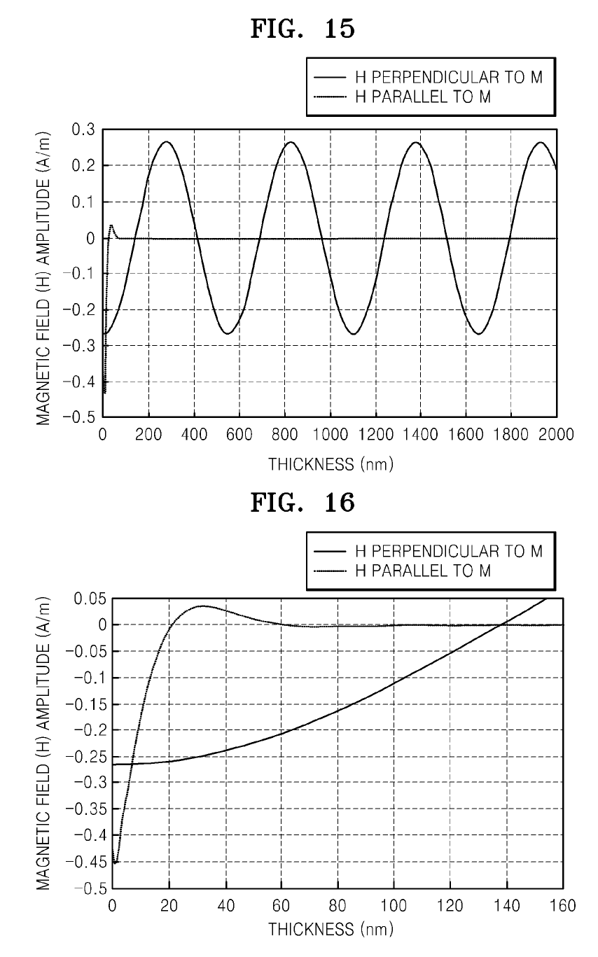

FIGS. 15 through 18 show the results of simulations to confirm the characteristic of the magnetic material layer 130. FIG. 15 is a graph showing the intensity (A/m) of a magnetic field that varies according to time and passes through the magnetic material layer 130 when the magnetic field is applied. FIG. 16 is a graph showing an enlarged portion of FIG. 15. The graphs of FIGS. 15 and 16 show the results of calculation when titanium is used as a material for the magnetic material layer 130 and the wavelength of the incident light is 550 nm. Titanium has a magnetic susceptibility of about 18×10⁻⁵ and an electric conductivity of about 2.38×10⁶ S (Siemens) at a room temperature of 20° C., as it is well known to one skilled in the art. As shown in FIGS. 15 and 15, when a magnetic field perpendicular to the magnetism direction of the magnetic material layer 130 is applied, even if the thickness t of the magnetic material layer 130 is increased, the magnetic field passes through the magnetic material layer 130 without an attenuation loss. In contrast, the amplitude of the light parallel to the magnetization direction of the magnetic material layer 130 is greatly attenuated to nearly 0 at the wavelength of about 60 nm. Thus, when the titanium is used as a magnetic material of the magnetic material layer 130, it is appropriate that the thickness t of the magnetic material layer 130 be about 60 nm.

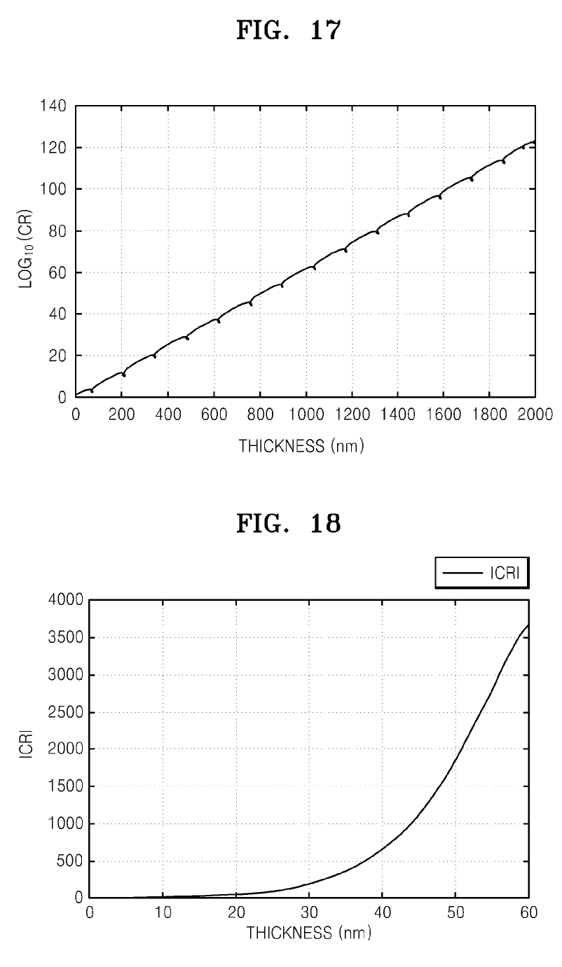

FIG. 17 is a graph showing a log value, that is, log₁₀ CR, of a contrast ratio CR of the magnetic material layer 130 according to the thickness t of the magnetic material layer 130, that is, a ratio of the transmittance of a light having a magnetic field perpendicular to the magnetization direction with respect to the transmittance of a light having a magnetic field parallel to the magnetization direction. FIG. 18 is a graph showing the absolute value of the contrast ratio of the magnetic material layer 130. For example, when “W1” is a light to be transmitted and “W2” is a light that must not be transmitted, the contrast ratio can be defined to be W1/W2. For the magnetic material layer 130, “W1” is S=E_{|}×H_{|} and “W2” is S_{∥}=E_{∥}×H_{∥}. The graphs of FIGS. 17 and 18 show that the contrast ratio greatly increases as the thickness t of the magnetic material layer 130 increases.

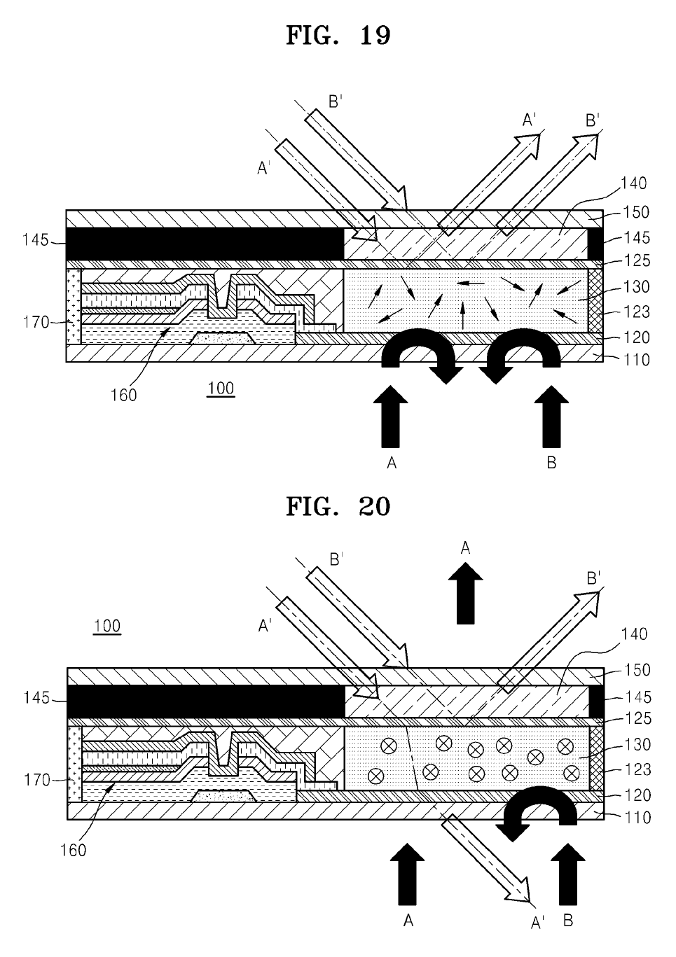

FIG. 19 is a cross-sectional view schematically illustrating an operation when the sub-pixel 100 of a magnetic display panel according to the present invention is in an OFF state.

In the operation of the sub-pixel 100 of a magnetic display panel using the magnetic material layer 130 as an optical shutter, referring to FIG. 19, the control circuit 160 is in an OFF state so that a current does not flow into the sub-pixel electrode 120. In this case, since a magnetic field is not applied to the magnetic material layer 130, the magnetic moments in the magnetic material layer 130 are oriented in random directions. Thus, as described above, all of the light incident on the magnetic material layer 130 is reflected. As shown in FIG. 19, all of the lights A and B, output from a backlight unit and input to the magnetic material layer 130 through the first transparent substrate 110, are reflected from the magnetic material layer 130. Also, all of the external lights A′ and B′, input to the magnetic material layer 130 through the second transparent substrate 150, are reflected from the magnetic material layer 130.

FIG. 20 illustrates a case in which the control circuit 160 is in an ON state so that a current flows into the sub-pixel electrode 120. In this case, since the magnetic field is applied to the magnetic material layer 130 through the sub-pixel electrode 120, the magnetic moments in the magnetic material layer 130 are all oriented in one direction. Thus, as described above, the light of a polarization component related to a magnetic field component parallel to the magnetization direction of the magnetic material layer 130 (hereinafter, referred to as light of a parallel polarization component) is reflected from the magnetic material layer 130. The light of a polarization component related to a magnetic field component perpendicular to the magnetization direction (hereinafter, referred to as light of a perpendicular polarization component) passes through the magnetic material layer 130.

For example, as shown in FIG. 20, of the light output from the backlight unit and input to the magnetic material layer 130 through the first transparent substrate 110, the light A of a perpendicular polarization component passes through the magnetic material layer 130 and contributes to the formation of an image. Meanwhile, the light B of a parallel polarization component is reflected from the magnetic material layer 130. The reflected light B can be reflected again, for example, by a mirror provided under the backlight unit, and then changed to a light in a non-polarized state using a diffusion plate . Thus, the light of a reflected parallel polarization component can be reused as the above-described step.

Also, of the external light input to the magnetic material layer 130 through the second transparent substrate 150, the light A′ of a perpendicular polarization component passes through the magnetic material layer 130. As already described with reference to FIG. 1, when a semi-transmissive mirror is formed on at least one of the surfaces from the magnetic material layer 130 to the first transparent substrate 110, the external light A′ of a perpendicular polarization component is reflected again to be used for the formation of an image. In contrast, the light B′ of a parallel polarization component input to the magnetic material layer 130 through the second transparent substrate 150 is reflected from the surface of the magnetic material layer 130. The reflected light B′ does not contribute to the formation of an image and may tire the eyes of a viewer. Thus, it is possible to arrange an absorptive polarizer to absorb the light B′ of a parallel polarization component on any of the surfaces from the magnetic material layer 130 to the second transparent substrate 150. Also, as already described with reference to FIG. 1, an antireflection coating can be formed on at least one of the optical surfaces from the magnetic material layer 130 to the second transparent substrate 150.

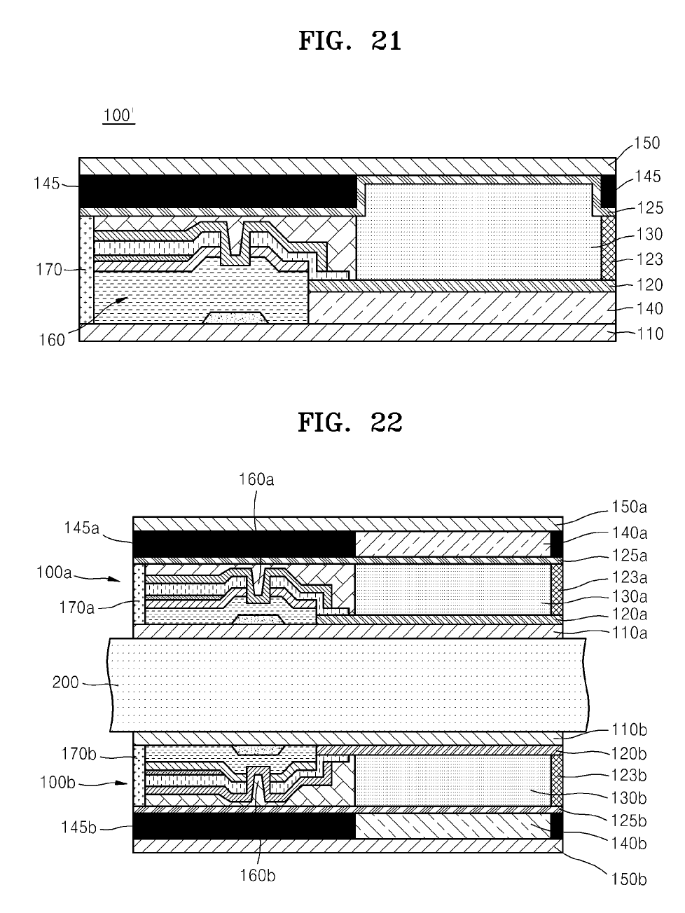

FIG. 21 schematically illustrates the structure of a sub-pixel 100′ of a magnetic display panel, according to another exemplary embodiment of the present invention. By comparing the sub-pixel 100′ to the sub-pixel 100 of the magnetic display panel of FIG. 1, in the sub-pixel 100′ of the magnetic display panel of FIG. 21, the color filter 140 is arranged between the first transparent substrate 110 and the sub-pixel electrode 120. Also, the black matrix 145 is arranged between the second transparent substrate 150 and the common electrode 125. Accordingly, the second transparent substrate 150 and the common electrode 125 directly contact each other in an area of the magnetic material layer 130. In the structure, the antireflection coating or absorptive polarizer can be formed on at least one of the optical surfaces from the magnetic material layer 130 to the second transparent substrate 150, for example, the surface between the magnetic material layer 130 and the common electrode 125, the surface between the common electrode 125 and the second transparent substrate 150, and the upper surface of the second transparent substrate 150. Also, the mirror or semi-transmissive mirror, for the reuse of the external light passing through the magnetic material layer 130, is appropriately formed on the surface between the color filter 140 and the first transparent substrate 110 or the lower surface of the first transparent substrate 110. In the present exemplary embodiment of FIG. 21, since a light having a high intensity emitted from the backlight unit first passes through the color filter 140, the effect of the light on the magnetic material layer 130 can be reduced. Although in FIG. 21, the color filter 140 is located between the first transparent substrate 110 and the sub-pixel electrode 120, the present invention is not limited thereto, and thus, the color filter 140 can be arranged between the magnetic material layer 130 and the sub-pixel electrode 120.

FIG. 22 is a cross-sectional view schematically illustrating the structure of a double-sided display panel using the sub-pixel 100 of FIG. 1, according to an exemplary embodiment of the present invention. In FIG. 22, the structure of only one sub-pixel is illustrated for convenience of explanation. Referring to FIG. 22, a sub-pixel 100a of a first magnetic display panel and a sub-pixel 100b of a second magnetic display panel are symmetrically arranged on both sides of a backlight unit 200. The structures of the sub-pixels 100a and 100b of the first and second magnetic display panels are the same as that of the sub-pixel 100 of the magnetic display panel of FIG. 1. That is, the sub-pixels 100a and 100b of the first and second magnetic display panels respectively include first transparent substrates 110a and 110b and second transparent substrates 150a and 150b which are arranged to face each other, magnetic material layers 130a and 130b respectively filling gaps between the first and second transparent substrates 110a and 150a and the first and second transparent substrates 110b and 150b, sub-pixel electrodes 120a and 120b respectively formed on parts of inner surfaces of the first transparent substrates 110a and 110b, color filters 140a and 140b respectively arranged on inner surfaces of the second transparent substrates 150a and 150b, common electrodes 125a and 125b respectively arranged on surfaces of the color filters 140a and 140b, and conductive spacers 123a and 123b respectively arranged at side surfaces of the magnetic material layers 130a and 130b to seal the magnetic material layers 130a and 130b and electrically connect the sub-pixel electrode 120a and the common electrode 125a and the sub-pixel electrode 120b and the common electrode 125b. According to the present invention, the sub-pixels 100a and 100b of the first and second magnetic display panels arranged at both sides of the backlight unit 200 can be independently turned on/off.

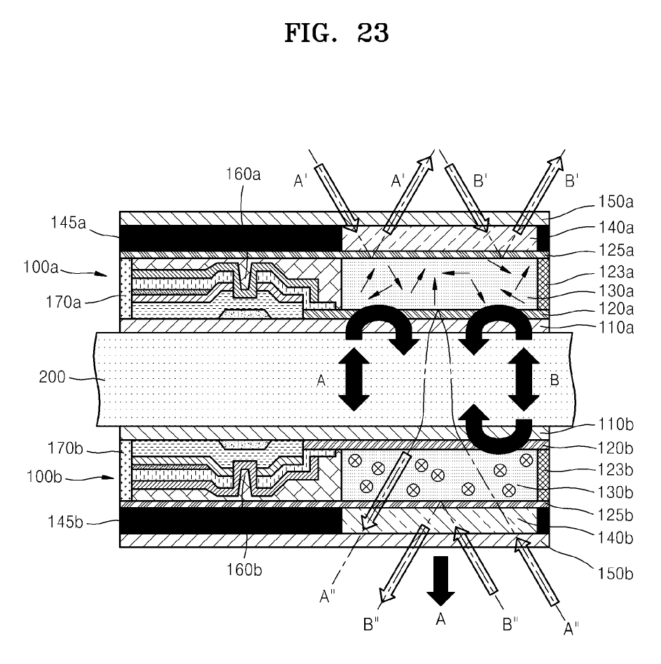

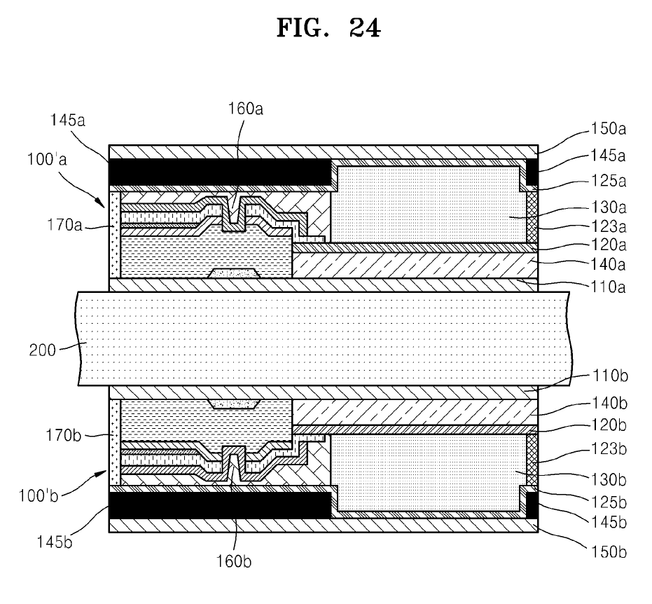

FIG. 23 is a cross-sectional view schematically illustrating the operation of the sub-pixels 100a and 100b of the double-sided display panel of FIG. 22. In FIG. 23, the sub-pixel 100a of the first magnetic display panel is in an OFF state and the sub-pixel 100b of the second magnetic display panel is in an ON state. In this case, since the sub-pixel 100a of the first magnetic display panel is in an OFF state, all of the lights A and B from the backlight unit 200 and all of the external lights A′ and B′ incident on the magnetic material layer 130a of the sub-pixel 100a of the first magnetic display panel are reflected from the magnetic material layer 130a.

However, since the sub-pixel 100b of the second magnetic display panel is in the ON state, of the light emitted from the backlight unit 200 and incident on the magnetic material layer 130b through the first transparent substrate 110b, the light A of a perpendicular polarization component passes through the magnetic material layer 130b to contribute to the formation of an image of the sub-pixel 100b of the second magnetic display panel. Also, the light B of a parallel polarization component is reflected from the magnetic material layer 130b of the sub-pixel 100b of the second magnetic display panel. The light B of a parallel polarization component is reflected from the magnetic material layer 130a of the sub-pixel 100a of the first magnetic display panel and incident again on the magnetic material layer 130b of the sub-pixel 100b of the second magnetic display panel. Thus, when a diffusion plate is provided in the backlight unit 200, it is possible to change the light B of a parallel polarization component, which is reflected, to a non-polarized light and reuse the light B of a parallel polarization component.

Of the external light incident on the magnetic material layer 130b through the second transparent substrate 150b of the sub-pixel 100b of the second magnetic display panel, light A″ of a perpendicular polarization component passes through the magnetic material layer 130b. Then, the light A″ of a perpendicular polarization component is reflected from the magnetic material layer 130a of the sub-pixel 100a of the first magnetic display panel and incident again on the magnetic material layer 130b of the sub-pixel 100b of the second magnetic display panel. Since the light A″ of a perpendicular polarization component, which is incident on the magnetic material layer 130b, passes through the magnetic material layer 130b, the light A″ of a perpendicular polarization component contributes to the formation of an image of the sub-pixel 100b of the second magnetic display panel. Also, the same effect can be obtained when a semi-transmissive mirror is formed on at least one of the surfaces from the magnetic material layer 130b to the first transparent substrate 110b of the second magnetic display panel. In this case, part of the light A″ of a perpendicular polarization component, which passes through the magnetic material layer 130b, is reflected from the semi-transmissive mirror and the remaining light is reflected from the magnetic material layer 130a of the sub-pixel 100a of the first magnetic display panel. The external light B″ of a parallel polarization component is reflected from the magnetic material layer 130b of the sub-pixel 100b of the second magnetic display panel. Thus, as described above, an absorptive polarizer or an anti-reflection coating can be installed on at least one of the optical surfaces from the magnetic material layer 130b to the second transparent substrate 150b of the second magnetic display panel, so as to absorb the external light B″ of a parallel polarization component.

Although it is not illustrated, when both of the sub-pixel 100a of the first magnetic display panel and the sub-pixel 100b of the second magnetic display panel are in the ON state, of the light emitted from the backlight unit 200, the light A of a perpendicular polarization component passes through the magnetic material layers 130a and 130b of the sub-pixels 100a and 100b of the first and second magnetic display panels and contributes to the formation of an image of the sub-pixels 100a and 100b of the first and second magnetic display panels. Also, the external light A′ of a perpendicular polarization component incident on the magnetic material layer 130a through the second transparent substrate 150a of the sub-pixel 100a of the first magnetic display panel passes through the magnetic material layer 130a. Then, part of the external light A′ of a perpendicular polarization component passes through the magnetic material layer 130b of the sub-pixel 100b of the second magnetic display panel to contribute to the formation of an image of the sub-pixel 100b of the second magnetic display panel.

The other part of the external light A′ of a perpendicular polarization component is reflected from the semi-transmissive mirror formed on at least one of the surfaces from the magnetic material layer 130a to the first transparent substrate 110a of the first magnetic display panel, to contribute to the formation of an image of the sub-pixel 100a of the first magnetic display panel. Likewise, the external light A″ of a perpendicular polarization component incident on the magnetic material layer 130b through the second transparent substrate 150b of the sub-pixel 100b of the second magnetic display panel passes through the magnetic material layer 130b. Then, part of the external light A″ of a perpendicular polarization component passes through the magnetic material layer 130a of the sub-pixel 100a of the first magnetic display panel, to contribute to the formation of an image of the sub-pixel 100a of the first magnetic display panel. The other part of the external light A″ of a perpendicular polarization component is reflected from the semi-transmissive mirror formed on at least one of the surfaces from the magnetic material layer 130b to the first transparent substrate 110b of the second magnetic display panel, to contribute to the formation of an image of the sub-pixel 100b of the second magnetic display panel.

FIG. 24 is a cross-sectional view schematically illustrating the structure of a double-sided display panel using the sub-pixel 100′ of FIG. 21, according to an exemplary embodiment of the present invention. Referring to FIG. 24, a sub-pixel 100′a of a third magnetic display panel and a sub-pixel 100′b of a fourth magnetic display panel are arranged at both sides of the backlight unit 200. The structures of the sub-pixels 100′a and 100′b of the third and fourth magnetic display panels are the same as that of the sub-pixel 100′ of the magnetic display panel of FIG. 21. Like the case of FIG. 22, the sub-pixels 100′a and 100′b of the third and fourth magnetic display panels can be independently turned on/off. The sub-pixels 100′a and 100′b of the double-sided display panel of FIG. 24 can be operated in the same manner as that of the sub-pixels 100a and 100b of the double-sided display panel of FIG. 23.

The present invention can be applied not only to a flat display that is not flexible and solid, however, also to a flexible display that can be easily bent. A conventional LCD panel that needs a high temperature process during the manufacturing process cannot use a flexible substrate that is weak at a high temperature so as not to be used as a flexible display. However, since the magnetic material layer 130, which is the core part of the present invention, can be manufactured in a low temperature process at about 130° C., the magnetic material layer 130 can be used for the manufacturing of a flexible display.

To use the magnetic display panel according to the present invention as a flexible display, all constituent elements must be formed of a flexible material. Referring to FIG. 1, as for the materials for the first and second transparent substrates 110 and 150, a light transmission resin material such as polyethylene naphthalate (PEN), polycarbonate (PC), and polyethylene terephthalate (PET) can be used. Also, a conductive polymer material such as iodine-doped polyacetylene can be used for the sub-pixel electrode 120 and the common electrode 125. Since the iodine-doped polyacetylene has a very high conductivity similar to silver, but is opaque, the iodine-doped polyacetylene is not used for the conventional LCD panel. However, as described above, in the present invention, the sub-pixel electrode 120 and the common electrode 125 do not need to be transparent. For the control circuit 160, an organic TFT, which is well known to one skilled in the art and mainly used for a conventional flexible organic EL display or a flexible OLED display, can be used. Also, the mirror or semi-transmissive mirror formed on at least one of the surfaces from the magnetic material layer 130 to the first transparent substrate 110 is formed of not a metal mirror, however, a dielectric mirror. The backlight unit 200 can also be formed using a flexible light guide panel formed of the above-described flexible light transmissive material for an edge type of backlight unit 200. A directly type backlight can be formed by arranging light sources on a flexible substrate.

When the magnetic display panel according to the present invention is applied to a paper-like flexible display, a glow material is used for the light sources instead of the backlight unit 200. For example, a glow material such as ZnS:Cu (copper-activated zinc sulfide) or ZnS:Cu,Mg (Copper and magnesium activated zinc sulfide) can be used for the light sources instead of the backlight unit 200.

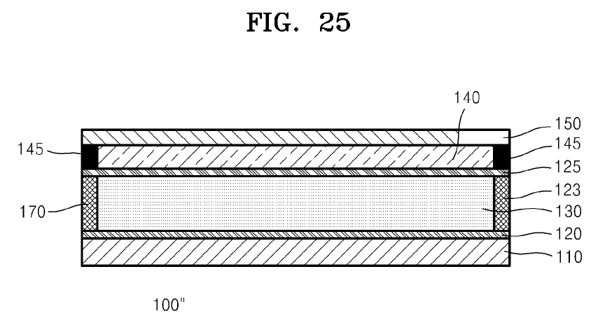

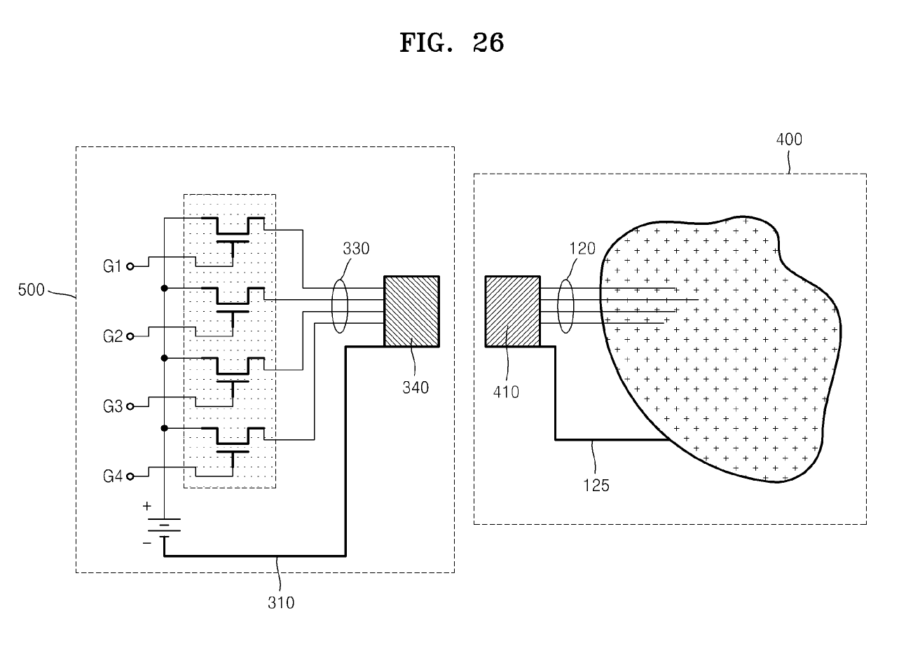

Also, as another example of the flexible display, an inorganic TFT can be used instead of an organic TFT. Since the inorganic TFT has a hard structure and needs a high temperature process, a flexible display unit and a control portion are separately manufactured by separating only a transistor portion from the structure of a sub-pixel. FIG. 25 schematically illustrates the structure of a sub-pixel 100″ of a flexible magnetic display panel, according to another exemplary embodiment of the present invention. The sub-pixel 100″ of a flexible magnetic display panel of FIG. 25 is different from the sub-pixel 100 of the magnetic display panel of FIG. 1 in that the control circuit 160 is removed from the sub-pixel 100″. The other structures of the elements of the sub-pixel 100″ of a flexible magnetic display panel of FIG. 25 are the same as those of the sub-pixel 100 of the magnetic display panel of FIG. 1. Also, the above-described flexible materials are used for the first and second transparent substrates 110 and 150, the sub-pixel electrode 120, and the common electrode 125.

FIG. 26 is a conceptual view illustrating the connection structure between a control portion 500 and a flexible display unit 400. As shown in FIG. 26, separately provided are the control portion 500 formed of a plurality of inorganic TFTs to drive each of the sub-pixels of the flexible display unit 400, and the flexible display unit 400 in which the control circuit 160 such as a transistor is removed from each sub-pixel. The control portion 500 includes a plurality of inorganic TFTs corresponding to the sub-pixels of the flexible display unit 400 and a first connector 340 for the connection with the flexible display unit 400. The first connector 340 electrically connects a plurality of sub-pixel electrodes 330 with drains of the inorganic TFTs, and a common electrode 310 with sources of the inorganic TFTs. Also, the flexible display unit 400 includes a second connector 410 that can couple with the first connector 340 of the control portion 500. The second connector 410 is electrically connected to the sub-pixel electrodes 120 and the common electrode 125 of the flexible display unit 400. Thus, when the first connector 340 and the second connector 400 are connected to each other, it is possible to control the on/off of each sub-pixel in the flexible display unit 400 through the control portion 500.

While this invention has been particularly shown and described with reference to exemplary embodiments thereof, it will be understood by one skilled in the art that various changes in form and details may be made therein without departing from the spirit and scope of the invention as defined by the appended claims.

As described above, according to a magnetic display panel of the present invention, an optical shutter for controlling the transmission/blocking of light with a small number of parts as compared to a conventional LCD panel can be provided. Thus, as compared to the conventional LCD panel, a display panel can be manufactured simply and at a low cost.

Also, the magnetic display panel according to the present invention can utilize most of the manufacturing processes of the conventional LCD panel. Furthermore, the magnetic display panel according to the present invention does not require a high temperature process, and can be applied to a flexible display.

The magnetic display panel according to the present invention can be manufactured not only in a small area, however, also in a large area with ease. Thus, the magnetic display panel according to the present invention can be widely applied to a variety of electronic devices providing an image such as TVs, PCs, notebook computers, mobile phones, PMPs, or game consoles.

What is claimed is:

1. A display pixel comprising:
a magnetic material layer that transmits light or reflects light based on whether a magnetic field is applied;
a first electrode disposed at a first surface of the magnetic material layer;
a second electrode disposed at a second surface of the magnetic material layer; and
a spacer disposed at a third surface of the magnetic material layer, electrically connecting the first electrode and the second electrode.

2. The display pixel of claim 1, wherein the magnetic material layer transmits light of a first polarization direction and reflects light of a second polarization direction perpendicular to the first polarization direction when the magnetic field is applied and reflects the light of the first polarization direction and the light of the second polarization direction when the magnetic field is not applied.

3. The display pixel of claim 1, wherein the magnetic material layer comprises a transparent medium and a plurality of magnetic particles distributed in the transparent insulation medium such that the plurality of magnetic particles are not agglomerated.

4. The display pixel of claim 3, wherein a thickness of the magnetic material layer is greater than a magnetic decay length of the magnetic material layer.

5. The display pixel of claim 3, wherein the plurality of magnetic particles include core-shell structures.

6. The display pixel of claim 5, wherein each of the core-shell structured plurality of magnetic particles includes a magnetic core formed of a magnetic material and an insulation shell surrounding the magnetic core.

7. The display pixel of claim 6, wherein the magnetic core includes a single magnetic domain.

8. The display pixel of claim 6, wherein the magnetic core is formed of a material selected from the group consisting of titanium, aluminum, barium, platinum, sodium, strontium, magnesium, dysprosium, manganese, gadolinium, silver, copper, chrome, nickel, iron, cobalt, and iron oxide, or an alloy comprising at least two materials of the group.

9. The display pixel of claim 1, wherein the magnetic material layer comprises a plurality of magnetic particles including cylindrical shapes, distributed in a transparent insulation medium such that the plurality of magnetic particles are not combined together.

10. The display pixel of claim 1, further comprising a first transparent substrate disposed at the first electrode and a second transparent substrate disposed at the second electrode.

11. The display pixel of claim 10, further comprising a color filter disposed between the second electrode and the second transparent substrate or between the first electrode and the first transparent substrate.

12. The display pixel of claim 11, further comprising an antireflection coating which is formed at at least one of surfaces between the magnetic material layer and a surface of the second transparent substrate, and the surface of the second transparent substrate.

13. The display pixel of claim 11, further comprising an absorptive polarizer disposed at at least one of surfaces between the magnetic material layer and a surface of the second transparent substrate, and the surface of the second transparent substrate.

14. The display pixel of claim 11, further comprising a mirror or a semi-transmissive mirror disposed at at least one of surfaces between the magnetic material layer and a surface of the first transparent substrate, and the surface of the first transparent substrate.

15. The display pixel of claim 1, wherein the first electrode, the second electrode, and the conductive spacer are formed of a material selected from the group consisting of aluminum, copper, silver, platinum, gold, barium, chromium, sodium, strontium, magnesium, and iodine-doped polyacetylene.

16. The display pixel of claim 15, wherein a plurality of first holes are formed in an area of the first electrode facing the magnetic material layer, light passes through the plurality of first holes, and a plurality of wires extending in a direction in which currents flow, are formed at the plurality of first holes.

17. The display pixel of claim 15, wherein a second hole is formed in an area of the second electrode facing the magnetic material layer, and light passes through the second hole.

18. The display pixel of claim 15, wherein the second electrode comprises a wire in a mesh structure or a lattice structure, electrically connected to the conductive spacer.

19. The display pixel of claim 1, further comprising a control circuit disposed at a fourth surface of the magnetic material layer and switching a flow of a current between the first electrode and the second electrode.

20. The display pixel of claim 19, further comprising a black matrix disposed at an area of a surface of the second electrode facing the control circuit and the conductive spacer.

21. A display panel comprising a plurality of the display pixels according to claim 1.

22. The display panel of claim 21, further comprising a first transparent substrate disposed at the first electrode and a second transparent substrate disposed at the second electrode in one of the plurality of the display pixels.

23. The display panel of claim 22, wherein the plurality of display pixels share the first transparent substrate, the second transparent substrate, and the second electrode in a common manner, and the first electrode generates a magnetic field to the magnetic material layer in the one of the plurality of the display pixels.

24. The display panel of claim 22, wherein the display panel is a flexible display panel in which the first transparent substrate, the second transparent substrate, the first electrode, and the second electrode are formed of flexible materials.

25. The display panel of claim 24, further comprising a display unit in which the plurality of the display pixels are disposed and a separate control portion to independently switch flows of currents between the first and second electrodes in each of the plurality of display pixels.
